(19) United States
(12) Patent Application Publication
(10) Pub. No.: US 2022/0396032 A1
(43) Pub. Date: Dec. 15, 2022

(54) 3D PRINTING CLEANING MODULES

(71) Applicant: Hewlett-Packard Development Company, L.P., Spring, TX (US)

(72) Inventors: Pablo Antonio Murciego Rodriguez, Sant Cugat del Valles (ES); Ernesto Alejandro Jones Poppescou, Sant Cugat del Valles (ES); Arturo Garcia Gomez, Sant Cugat del Valles (ES)

(21) Appl. No.: 17/775,575

(22) PCT Filed: Jan. 29, 2020
(86) PCT No.: PCT/US2020/015524

§ 371 Date: May 9, 2022

(51) Int. Cl. B29C 64/35; B33Y 40/20; B22F 10/68; B28B 11/22; B08B 5/02; B08B 7/02; B08B 7/04; B08B 13/00

(52) U.S. Cl. CPC B29C 64/35; B33Y 40/20; B22F 10/68; B28B 11/22; B08B 5/02; B08B 7/02; B08B 7/04; B08B 13/00

(57) ABSTRACT

A 3D printing cleaning module comprises an extraction gate at a lateral wall of a housing; and a platform within the housing to support a build bed including 3D printed parts and un-solidified build material. The platform is tilted or tiltable with respect to a horizontal plane towards the extraction gate to enable 3D printed parts on the platform to be removable through the extraction gate. The module comprises a cleaning engine to remove at least part of the un-solidified build material from the housing, a vibrating mechanism to vibrate the platform; and a controller. The controller is to control the cleaning engine to execute a cleaning operation by removing un-solidified build material from the housing, to cause the part ejection gate to open upon completion of the cleaning operation, and to cause the vibrating mechanism to vibrate the platform when the part extraction gate is in the open position.

### BACKGROUND

Some additive manufacturing or three-dimensional printing systems generate 3D objects by selectively solidifying portions of a successively formed layers of build material in a layer-by-layer basis. At the end of the 3D printing process, un-solidified portions of build material have to be separated from the generated objects.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a 3D printing cleaning module.

FIG. 2A is a flowchart of an example method of removing un-solidified build material from 3D printed parts in the 3D printing cleaning module.

FIG. 2B is a flowchart of another example method of removing un-solidified build material from 3D printed parts in the 3D printing cleaning module.

FIG. 3A is another schematic diagram showing an example of a 3D printing cleaning module.

FIG. 3B is another schematic diagram showing an example of a 3D printing cleaning module.

FIG. 4 is a schematic diagram showing an example of a 3D printing cleaning module with a conveying system.

FIG. 5 is a flowchart of an example method of removing un-solidified build material from 3D printed parts in the 3D printing cleaning module.

FIG. 6 is a block-diagram of a processor-based system example for removing un-solidified build material from 3D printed parts in the 3D printing cleaning module.

### DETAILED DESCRIPTION

The following description is directed to various examples of additive manufacturing, or three-dimensional printing, apparatus and processes to generate 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printing systems generate a 3D object by executing a series of 3D printing operations. In some 3D printing systems, some of the 3D printing operations are distinct from each other and may be executed by different sub-systems of the 3D printing system. The sub-systems may be different depending on the type of material and 3D printing technology used. Some sub-systems may be physically placed at different locations. Other sub-systems may be integrated into a single housing.

Some 3D printers generate 3D objects by selectively processing layers of build material. For example, a 3D printer selectively solidifies portions of a layer of build material corresponding to a slice of 3D object to be generated, thereby leaving the portions of the layer un-solidified in the areas where no 3D object is to be generated. The combination of the generated 3D objects and the un-solidified build material is commonly referred to as build bed. The volume in which the build bed is generated is commonly referred to as a build chamber.

Suitable powder-based build materials for use in additive manufacturing may include, where appropriate, at least one of polymers, metal powder or ceramic powder. In some examples, non-powdered build materials may be used such as gels, pastes, and slurries.

3D printing systems may additionally execute cleaning operations to separate the generated 3D printed parts from the un-solidified build material. In some examples, the cleaning operations may be performed in the 3D printer. In other systems, the entire build bed is transferred to a 3D cleaning module where the cleaning operations are executed.

In some systems, a removable receptacle suitable to contain the build bed may be attached and detached from the different sub-systems of the 3D printing system according to the 3D printing system workflow. In some systems the removable receptacle is a build unit. A build unit may be a module that includes a build chamber where 3D objects are to be generated throughout the 3D printing process of the 3D printing system.

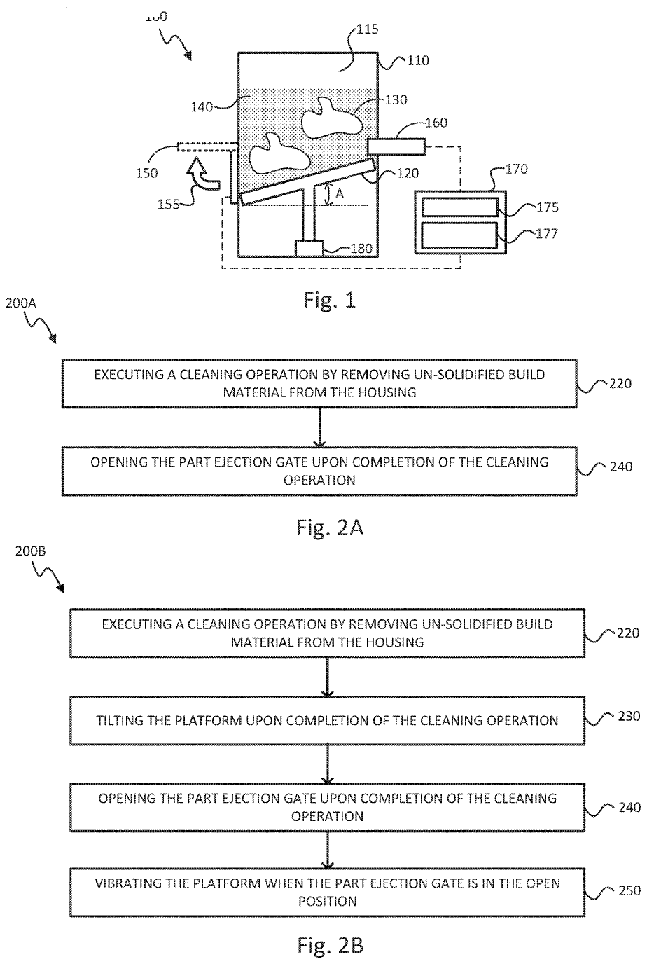

Referring now to the drawings, FIG. 1 is a schematic diagram showing a vertical cross-section of a 3D cleaning module 100 according to an example. The 3D cleaning module 100 may be a stand-alone system or may be a part of a build material processing station, a 3D printer, a cleaning station, or the like.

The 3D cleaning module 100 comprises a housing 110. The housing 110 is a receptacle defining a chamber 115 in which a platform 120 is located. In some examples, the platform 120 is permanently tilted or has a top surface with a predetermined slope, thereby not being fully comprised in a horizontal plane. In other examples, however, the platform 120 is tiltable with respect to a horizontal plane. In yet additional examples, the full 3D printing 100 with the platform 120 are tiltable so that once tilted, the platform 120 is tilted with respect to the horizontal plane. Some of the examples below disclose systems and methods for tilting a tiltable platform 120. In the examples herein, the platform 120 is tilted or tiltable towards an extraction gate 150 located at a lateral wall of the housing 110. Additionally, in some examples, the platform 120 may be moveable within the chamber 115 (e.g., vertically), through, for example, a platform drive mechanism 180. The platform 120 may be moved vertically within the chamber 115.

In the examples in which the platform 120 is tiltable, the platform 120 is tilted by means of a tilting mechanism. In some examples, the tilting mechanism is a drive mechanism which may be the same drive mechanism or a different drive mechanism than the drive mechanism 180 that causes the platform 120 to move vertically. In other examples, the tilting mechanism may be implemented as a plurality of drive mechanisms (see, e.g., examples below). In yet other examples, the tilting mechanism may be implemented as a physical linkage (not shown), e.g. a chain or a cable, actuatable to tilt the platform.

The tilting mechanism may tilt the platform 120 above a threshold angle. In an example, the tilting mechanism tilts the platform 120 for an angle A from the range of 2° to 60°, for example about 2°, 5°, 15°, 20°, 30°, 45° or 60°.

In some examples, the 3D cleaning module 100 comprises a sealing element (not shown) between the platform 120 and the housing 110 that enables sealing so that neither un-solidified build material 140 nor 3D printed parts 130 reach the volume below the platform 120. In an example, the sealing element is a foam. In some examples, the sealing element may be selected so that it enables sealing within a predetermined range of tilt angles. The angles than enable sealing by the sealing element may range from about 0° to 15°, for example, about 2°, 5°, 7°, 10°, 12° or 15°.

In the examples in which the 3D cleaning module 100 is included in a 3D printer, the chamber 115 may be referred to as a build chamber. The build chamber 115 enables the generation of layers of build material to be formed on the platform 120. In some examples, portions of the newly formed uppermost layer of build material may be selectively solidified (or partially solidified) to form a layer comprising at least a part of a 3D printed object 130 that is being generated. Upon the completion of the 3D object generation process, a cleaning operation to separate the 3D printed part 130 and the un-solidified build material is performed.

In other examples, however, the 3D cleaning module 100 is a stand-alone system which is not integrated into the 3D printer. In these examples, the build bed is generated in the 3D printer and is then transferred to the 3D cleaning module 100 through, for example, a transportation unit (not shown). The transportation unit may be an enclosure suitable to hold a build bed and engageable with the 3D cleaning module 100. In an example, upon completion of the build bed generation, the build bed is transferred to a transportation unit. In another example, the build bed is directly generated in a transportation unit within the 3D printer and, upon completion of the generation of the 3D object 130, the transportation unit with the build bed therein is transferred to the 3D cleaning module 100. The transportation unit with a build bed therein is engageable with the 3D cleaning module 100 in such a way that the build bed can be transferred from the inner volume of the transportation unit to the top surface of the platform 120. The platform 120 is therefore to support the build bed thereon.

In use, the build bed comprises un-solidified build material 140 and at least one 3D printed part 130 corresponding to a 3D object to be generated. As mentioned above, in the cleaning operation, the 3D cleaning module 100 is to separate the un-solidified build material 140 from the 3D printed parts 130. In some examples, the un-solidified build material may be recycled for use in a subsequent printing operation. Upon completion of the cleaning operation, the 3D cleaning module 100 executes an extraction operation to extract the 3D printed parts 130 out of the 3D cleaning module 100.

The 3D cleaning module 100 also comprises a cleaning engine 160 to remove at least part of the un-solidified build material 140 out of the housing 110. In some examples, the cleaning engine 160 is to apply a cleaning gas stream within the housing to clean the 3D printed part 130 (e.g., airknive) from un-solidified build material 140. In other examples, the cleaning engine 160 comprises a device that, when in use, generates an airflow (i.e., negative pressure) in the chamber 115 thereby transferring un-solidified build material 140 particles out of the chamber 115.

The cleaning engine 160 may be mounted or attached to a wall of the chamber 115. In some examples, the cleaning engine 160 is positioned in the vicinity of the upper surface of the platform 120. In other examples, the cleaning element 150 may be positioned towards a top portion of the housing 110 and above the platform 120 and, when in use, the cleaning engine 160 is to generate a cleaning stream generally towards the platform 120.

The cleaning engine 160 may additionally comprise a build material removal system to transfer the removed un-solidified build material from the cleaning operation to a reservoir outside of the chamber 115. In an example, the build material removal system is a pneumatic build material extraction device (e.g., a fan).

The 3D cleaning module 100 further comprises the extraction gate 150 at a lateral wall of the housing 110. The extraction gate 150 is to enable a manual or automatic extraction of the 3D printed parts 130 from the chamber 115. The extraction gate 150 may be located in such a way that, in its closed position, it covers an opening in a lateral wall from the housing 110 thereby inhibiting any element within the chamber 115 to be removed therefrom. The extraction gate 150, in its open position, uncovers at least part the opening from the lateral wall of the housing 110, thereby allowing elements within the chamber 115 (e.g., 3D printed parts 130) to be removed therefrom.

The extraction gate 150 may be implemented in a number of different ways. In an example, the extraction gate 150 is a sliding door controllable to slide laterally or vertically. In another example, the extraction gate 150 is a passive element coupled to the lateral wall of the housing 110 by means of a hinge (not shown). The hinge may be controllable to cause the extraction gate to swing upwards (illustrated arrow 155), downwards, or sideways.

As mentioned above, the platform 120 is tilted or tiltable with respect to the horizontal plane (see, e.g., illustrated angle A) towards the extraction gate 150. In an extraction operation, the platform 120 is tilted or tiltable in such a way that enables the 3D printed parts 130 on the platform 120 to be removed from the chamber 115 through the extraction gate 150.

Additionally, the 3D cleaning module 100 further comprises a vibrating mechanism (not shown) to vibrate the moveable platform 120. The vibrating mechanism 140 may vibrate and thereby transfer the vibration to the platform 120. The vibration is therefore transmitted to the build bed.

In a cleaning operation, the vibration may be applied when the extraction gate 150 is in its closed position. The vibration may loosen and/or break-up agglomerated build material allowing such build material to be removed out of the 3D cleaning module 100 by, for example, a sieve and/or a pneumatic extraction system (not shown).

In the extraction operation, the vibration may be activated when the extraction gate 150 is in its open position. The vibration may displace the 3D printed parts 130 on the platform 120 and thereby cause the 3D printed parts 130 to slide down the slope of the tilted platform 120 towards the extraction gate 150 to be further extracted from the 3D cleaning module 100. Extracting 3D printed parts 130 by applying the vibration allows the extraction of 3D printed parts 130 by tilting the platform with smaller slopes (i.e., smaller angle A) than the examples that extract 3D printed parts 130 without such vibration.

The vibrating mechanism may be controlled to vibrate at a specific frequency or range of frequencies. In an example, the vibrating mechanism cause the platform 120 to vibrate at a fixed frequency. In another example, the vibrating mechanism vibrates to cause the platform 120 to vibrate at a plurality of fixed frequencies spaced apart by a predetermined period of time (e.g., vibrating at a first frequency for a period of time followed by vibrating at a second frequency for a period of time). In yet a further example, the vibrating mechanism vibrates to cause the platform 120 to vibrate at a set of frequencies ranging from a lower end frequency to a higher end frequency. In an example, the vibrating mechanism 140 may cause the platform 120 to vibrate at a frequency ranging from 20 to 60 Hz, for example 30 Hz or 50 Hz. In another example, the vibrating mechanism 140 may cause the platform 120 to vibrate at a frequency ranging from 40 to 50 Hz.

The 3D cleaning module 100 further comprises a controller 170. The controller 170 comprises a processor 175 and a memory 177 with specific control instructions to be executed by the processor 175. The controller 170 is coupled to the cleaning engine 160 and the extraction gate 150. Additionally, the controller 160 may further be coupled to the platform drive mechanism 180 and/or the vibrating mechanism. The controller 170 may control the operations of the elements that it is coupled with. The functionality of the controller 170 is described further below.

In the examples herein, a controller may be any combinations of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller may be, at least partially, implemented in the form of an electronic circuitry. The controller may be a distributed controller, a plurality of controllers, and the like.

FIG. 2A is a flowchart of an example method 200A of removing un-solidified build material 140 from 3D printed parts 130 in the 3D cleaning module 100, for example the 3D cleaning module 100 of FIG. 1 where the platform 120 is a tilted platform. Method 200A may involve previously disclosed elements from FIG. 1 referred to with the same reference numerals. In some examples, method 200A may be executed by the controller 170.

Method 200A may start when a build bed comprising at least one 3D printed part 130 and un-solidified build material 140 is placed on the platform 120 of the 3D cleaning module 100.

At block 220, the controller 170 controls the cleaning engine 160 to execute a cleaning operation to remove un-solidified build material 140 from the housing 110. In an example, the controller 170 controls the cleaning module 150 to generate a cleaning stream in a predetermined manner. In another example, the controller 170 controls the cleaning engine 160 to generate an airflow to remove un-solidified build material 140 from the housing 110. Additionally, the controller 170 may control the vibrating mechanism to vibrate and thereby cause the platform 120 to vibrate at a predetermined frequency or range of frequencies to remove un-solidified build material 140 from the housing 110.

Upon completion of the cleaning operation, the controller 170 causes the part ejection gate 150 to open (block 240) so that the 3D printed parts 130 can be extracted from the housing 110 by sliding through the slope of the tilted platform 120. In some examples, the controller 170 controls the drive mechanism 180 to move the platform 120 to a position where the tilted platform is positioned towards the extraction gate 150. Additionally, the controller 170 may control the vibrating mechanism to vibrate and thereby cause the platform 120 to vibrate at a predetermined frequency or range of frequencies to cause the 3D printed parts 130 to be removed from the housing 110.

FIG. 2B is a flowchart of an example method 200B of removing un-solidified build material 140 from 3D printed parts 130 in the 3D cleaning module 100, for example the 3D cleaning module 100 of FIG. 1 where the platform 120 is a tiltable platform. Method 200B may involve previously disclosed elements from FIG. 1 referred to with the same reference numerals. In some examples, method 200B may be executed by the controller 170.

Method 200B may start when a build bed comprising at least one 3D printed part 130 and un-solidified build material 140 is placed on the platform 120 in the 3D cleaning module 100.

Block 220 from method 200B may be the same as or similar to block 220 from method 200A.

At block 230, upon the completion of the cleaning operation, the controller 170 controls the tilting mechanism to tilt the platform 120 with respect to a horizontal plane for a predetermined angle A. The tilting mechanism tilts the platform 120 towards the extraction gate 150. In some examples, the controller 170 controls the drive mechanism 180 to move the platform 120 to a position where the already tilted tiltable platform is positioned towards the extraction gate 150.

Block 240 from method 200B may be the same as or similar to block 240 from method 200A. Additionally, the method 200B may further execute block 250 where the controller 170 may control the vibrating mechanism to vibrate and thereby cause the platform 120 to vibrate at a predetermined frequency or range of frequencies to cause the 3D printed parts 130 to be removed from the housing 110.

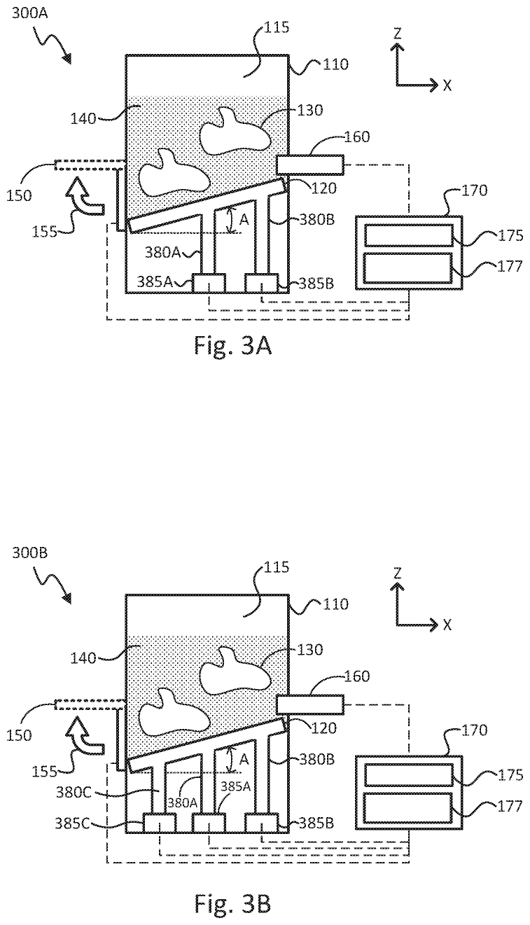

FIGS. 3A-3B illustrate example implementations of the 3D cleaning module (e.g., 3D cleaning module 100 from FIG. 1) that involve previously disclosed elements from FIG. 1 referred to with the same reference numerals. The 3D cleaning modules disclosed in FIGS. 3A-3C comprise the housing 110, the chamber 115, the platform 120, the 3D printed parts 130, the un-solidified build material 140, the extraction gate 150, the cleaning element 160, and the controller 170.

FIG. 3A shows an implementation of the 3D cleaning module 300A according to an example. The tilting mechanism from the cleaning module 300A comprises a first drive mechanism 380A attached to a first part of the platform 120 and a second drive mechanism 380B attached to a second part of the platform 120 different from the first part. In some examples, the first drive mechanism 380A comprises a first rotating device 385A connected to a first driving piston. The first rotating device 385A is controllable to rotate and thereby to move at least the first part of platform 120 where it is coupled vertically. The tilting mechanism from the 3D cleaning module 300A further comprises a second drive mechanism 380B attached to a second part of the platform 120. In some examples, the second drive mechanism 380B comprises a second rotating device 385B connected to a second driving piston. The second rotating device 385B is controllable to rotate and thereby move at least the second part of the platform 120 where it is coupled vertically.

The controller 170 is coupled to the first drive mechanism 380A and the second drive mechanism 380B. The controller 170 is to control the first drive mechanism 380A to move the first part of the platform 120 vertically and the second drive mechanism 380B to move the second part of the platform 120 vertically. The controller 170 may control the first and second drive mechanism 380A-B independently so that the first part and the second part can be controlled to be located at different heights. In some examples herein, the controller 170 is to adjust the heights of the first and second parts of the platform 120 so that the platform 120 is tilted for a predetermined angle A towards the extraction gate 150. The controller 170 may control the first and second drive mechanisms 380A-B to tilt the platform 120 when the extraction gate 150 is its open position.

FIG. 3B shows an implementation of the 3D cleaning module 300B according to a different example. The tilting mechanism of the 3D cleaning module 300B comprises a first drive mechanism 380A attached to a first part of the platform 120, a second drive mechanism 380B attached to a second part of the platform 120 and a third drive mechanism 380C attached to a third part of the platform 120. In some examples, each of the drive mechanism comprises a rotating device (385A-C respectively) connected to the platform 120 by means of a piston (380A-C respectively). The rotating devices 385A-C are controllable to rotate and thereby move the respective parts of the platform 120 vertically. The first part, the second part and the third part are spaced out at the bottom part of the platform 120 defining a plane so that controlling the position of the first, second and third parts enables a full control of the position of the platform 120.

The controller 170 is coupled to the first, second and third drive mechanisms 380A-C and is to control each drive mechanism independently. In the example, the controller 170 can independently modify the height of three parts of the platform 120, thereby having full control of the position of the platform 120 within the chamber 115. Therefore, in some examples, the controller 170 is to adjust the heights of the first, second and third parts of the platform 120 so that the platform 120 is tilted for a predetermined angle A towards the extraction gate 150. The controller 170 may control the first, second and third drive mechanisms 380A-C to tilt the platform 120 when the extraction gate 150 is in its open position.

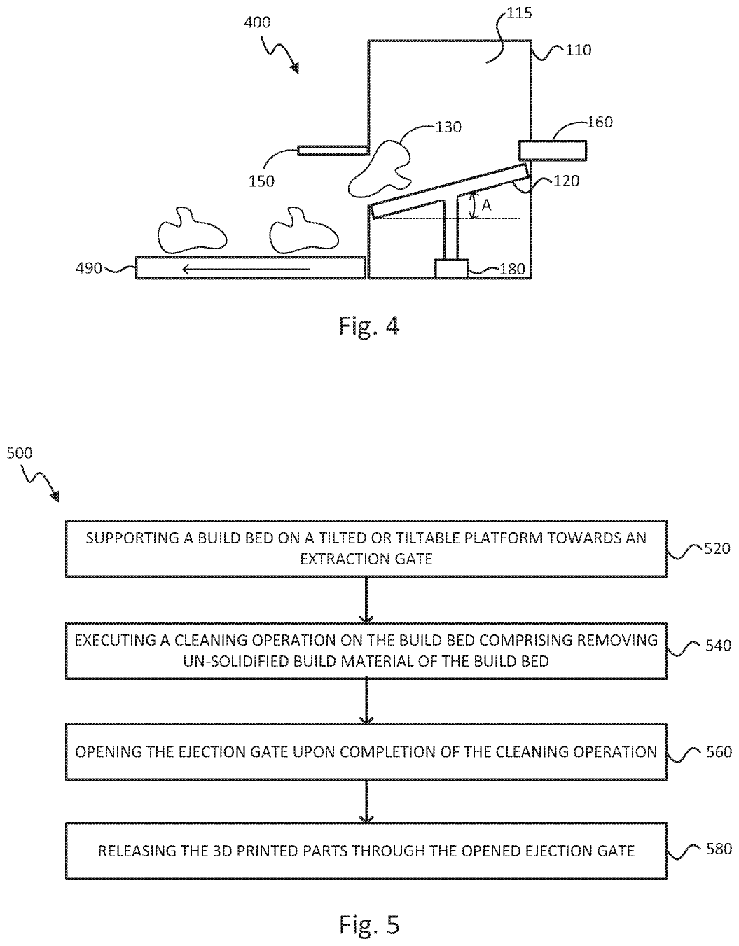

FIG. 4 is a schematic diagram showing an example of a 3D cleaning module 400 with a conveying system 490. The 3D cleaning module 400 involves previously disclosed elements from FIG. 1 referred to with the same reference numerals, for example, the housing 110, the chamber 115, the platform 120, the 3D printed parts 130, the un-solidified build material 140, the extraction gate 150, the cleaning element 160, and the controller 170 (not shown). In some examples, the 3D cleaning module 400 may include the tilting mechanism disclosed in FIG. 3A or 3B.

The outer part of the extraction gate 150 of the 3D cleaning module 400 is in contact (directly or indirectly) with a part conveying system 490. A part conveying system 490 may be any device suitable for conveying parts from the outer part of the extraction gate 150 to an external 3D system module (e.g., post-processing module). Some examples of a part conveying system 490 include a receptacle (not shown) to receive the extracted parts 130, the receptacle being placed on a conveyor belt to convey the receptacle. Other examples of a part conveying system 490 include a conveyor belt without any intermediate element between the extraction gate 150 and the conveyor belt. In these examples, the 3D parts 130 are extracted to the conveyor belt where they are conveyed to, for example, a post-processing module. In yet other examples, the part conveying system 490 includes a robotic arm that transports the 3D printed parts 130 from the outer part of the extraction gate 150 to a post-processing module.

As mentioned above, the extraction gate 150 may be opened by means of a controllable hinge. In an example, the controller 170 may control the hinge to open the extraction gate 150 upwardly (illustrated example), which enables an external part collecting element (e.g., the above-mentioned receptacle on the conveyor belt) to be positioned substantially in contact with the housing 110 below the opening where the 3D printed parts 130 are ejected therefrom. In another example, however, the controller 170 may control the hinge to open the extraction gate 150 downwardly, which enables the extraction gate 150 in the open position to act as an ejection ramp from the 3D cleaning module to the part conveying system 490. The ejection ramp mitigates the impact from the 3D printed parts 130 with the part conveying system 490 as it reduces the height in which the 3D printed parts 130 are dropped from.

FIG. 5 is a flowchart of an example method 500 of cleaning and ejecting 3D printed parts 130 from a 3D cleaning module (e.g., 3D cleaning module 100 from FIG. 1). Method 500 may involve previously disclosed elements referred to with the same reference numerals. In some examples, method 500 may be executed by the controller 170 from FIG. 1, 3A-B or 4.

At block 520, the platform 120 supports a build bed including 3D printed parts 130 and un-solidified build material 140. In an example, the platform 120 is permanently tilted with respect to a horizontal plane towards the extraction gate 150 to enable the 3D printed parts 130 on the platform 120 to be removable through the extraction gate 150. In another example, however, the platform 120 is tiltable with respect to the horizontal plane towards the extraction gate 150 to enable the 3D printed parts 130 on the platform 120 to be removable through the extraction gate 150. In this example, the method may further comprise tilting the platform through the tilting mechanism towards the extraction gate 150 of the 3D cleaning module 100.

At block 540, the cleaning element 160 executes a cleaning operation on the build bed to remove un-solidified build material 140 from the 3D cleaning module 100. At block 560, upon the completion of the cleaning operation, the ejection gate 150 opens and, at block 580, the 3D printed parts 130 are released through the opened ejection gate 150. In some examples, the method may further comprise to vibrate the tilted platform 120 through a vibrating mechanism to assist on the release of the 3D printed parts 130.

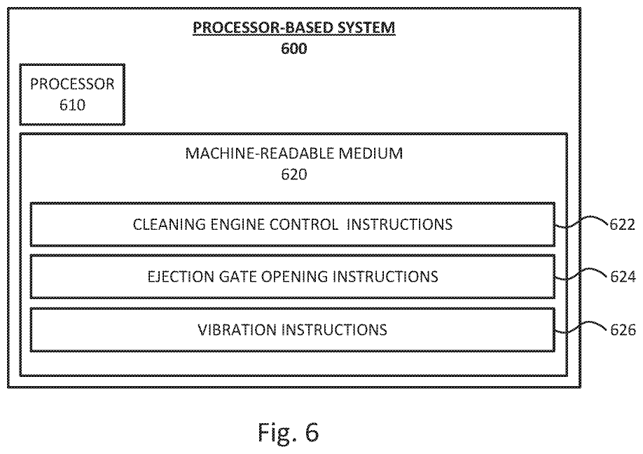

FIG. 6 is a block diagram illustrating an example of a processor-based system 600 that includes a machine-readable medium 620 encoded with example instructions to remove un-solidified build material 140 from 3D printed parts 130 in the 3D cleaning module 100. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 622-626) to perform functions related to various examples. Additionally, or alternatively, the processor 610 may include electronic circuitry for performing the functionality described herein, including the functionality of instructions 622-626. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 6, in which case the executable instructions may be deemed “installed” on the system 600. Alternatively, the machine-readable medium 620 may be a portable (e.g., external) storage medium, for example, that allows system 600 to remotely execute the instructions or download the instructions from the storage medium. In this case, the executable instructions may be part of an “installation package”. As described further herein below, the machine-readable medium may be encoded with a set of executable instructions 622-626

Instructions 622, when executed by the processor 610, may cause the processor 610 to control a cleaning engine 160 to execute a cleaning operation by removing un-solidified build material 140 from a build bed. Additionally, the machine-readable medium may comprise instructions to cause a tilting mechanism to tilt the platform 120 towards the part extraction gate 150.

Instructions 624, when executed by the processor 610, may cause the processor 610 to open the ejection gate 150 upon completion of the cleaning operation.

Instructions 626, when executed by the processor 610, may cause the processor 610 to cause a vibrating system to vibrate the platform 120.

As used herein, the terms “substantially” and “about” are used to provide flexibility to a range endpoint by providing a degree of flexibility. The degree of flexibility of this term can be dictated by the particular variable and would be within the knowledge of those skilled in the art to determine based on experience and the associated description herein.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A 3D printing cleaning module comprising:
an extraction gate at a lateral wall of a housing;
a platform within the housing to support a build bed including 3D printed parts and un-solidified build material, wherein the platform is tilted or tiltable with respect to a horizontal plane towards the extraction gate to enable 3D printed parts on the platform to be removable through the extraction gate;
a cleaning engine to remove at least part of the un-solidified build material out of the housing;
a vibrating mechanism to vibrate the platform; and
a controller to:
   control the cleaning engine to execute a cleaning operation by removing un-solidified build material from the housing;
   cause the part ejection gate to open upon completion of the cleaning operation; and
   cause the vibrating mechanism to vibrate the platform when the part ejection gate is in the open position.

Feature set 2: A 3D printing cleaning module with feature set 1, wherein the controller is to control the vibrating mechanism to cause the platform to vibrate at a frequency ranging from 20 to 60 Hz.

Feature set 3: A 3D cleaning module with any preceding feature set 1 to 2, further comprising a tilting mechanism to cause the platform to tilt with respect to the horizontal plane and the controller to control the tilting mechanism to tilt upon completion of the cleaning operation.

Feature set 4: A 3D cleaning module with any preceding feature set 1 to 3, further comprising a drive mechanism to move the platform vertically and the controller is to control the drive mechanism to move the platform to a predetermined position so that the platform is directed to the extraction gate when the platform is in a tilted position.

Feature set 5: A 3D cleaning module with any preceding feature set 1 to 4, further comprising a sealing element between the platform and the housing that enables sealing regardless of the angle caused by the platform once tilted, wherein the angle is of the range of 0 to 15 degrees.

Feature set 6: A 3D cleaning module with any preceding feature set 1 to 5, wherein the tilting mechanism comprises: a first drive mechanism attached to a first part of the platform, and a second drive mechanism attached to a second part of the platform; and the controller is to independently control the first and second drive mechanisms to tilt the platform.

Feature set 7: A 3D cleaning module with any preceding feature set 1 to 6, wherein the tilting mechanism comprises: a first drive mechanism attached to a first part of the platform, a second drive mechanism attached to a second part of the platform, and a third drive mechanism attached to a third part of the platform; wherein the first part, second part, and third part are spaced out defining a plane; and the controller to independently control the first, second and third drive mechanisms to tilt the platform.

Feature set 8: A 3D cleaning module with any preceding feature set 1 to 6, wherein the tilting mechanism is connectable to an external physical linkage actuatable to tilt the platform.

Feature set 9: A 3D cleaning module with any preceding feature set 1 to 8, wherein an outer part of the extraction gate is in such position that the 3D printed parts are to fall to a part conveying system.

Feature set 10: A 3D cleaning module with any preceding feature set 1 to 9, wherein the ejection gate is controllable to: open upwardly thereby enabling an external part collecting element to approach to the lateral wall of the housing; or open downwardly thereby the ejection gate serving as an ejection ramp from the 3D cleaning module to an external part collecting element.

Feature set 11: A method for cleaning and ejecting 3D printed parts from a 3D cleaning module, the method comprising
supporting a build bed on a platform, the build bed including 3D printed parts and un-solidified build material, wherein the platform is tilted or tiltable with respect to a horizontal plane towards an extraction gate to enable 3D printed parts on the platform to be removable through the extraction gate;
executing a cleaning operation on the build bed comprising removing un-solidified build material of a build bed from the 3D cleaning module;
opening the ejection gate upon completion of the cleaning operation; and
extracting the 3D printed parts through the opened ejection gate.

Feature set 12: A method with preceding feature set 11, further comprising tilting the platform through a tilting mechanism towards the extraction gate of the 3D cleaning module.

Feature set 13: A method with any preceding feature set 11 to 12, further comprising vibrating the platform by a vibrating mechanism when the part ejection gate is in the open position.

Feature set 14: A non-transitory machine-readable medium storing instructions executable by a processor, wherein a platform is to support a build bed including 3D printed parts and un-solidified build material, wherein the platform is tilted or tiltable with respect to a horizontal plane towards an extraction gate to enable 3D printed parts on the platform to be removable through the extraction gate, the non-transitory machine-readable medium comprising:
instructions to control a cleaning engine to execute a cleaning operation by removing un-solidified build material from the build bed;
instructions to open the ejection gate upon completion of the cleaning operation; and
instructions to cause a vibrating mechanism to vibrate the platform.

Feature set 15: A non-transitory machine-readable medium with feature set 14, further comprising instructions to cause a tilting mechanism to tilt the platform towards the part extraction gate.

What it is claimed is:

1. A 3D printing cleaning module comprising:
an extraction gate at a lateral wall of a housing;
a platform within the housing to support a build bed including 3D printed parts and un-solidified build material, wherein the platform is tilted or tiltable with respect to a horizontal plane towards the extraction gate to enable 3D printed parts on the platform to be removable through the extraction gate;
a cleaning engine to remove at least part of the un-solidified build material out of the housing;
a vibrating mechanism to vibrate the platform; and
a controller to:
control the cleaning engine to execute a cleaning operation by removing un-solidified build material from the housing,
cause the part ejection gate to open upon completion of the cleaning operation, and
cause the vibrating mechanism to vibrate the platform when the part ejection gate is in the open position

2. The 3D printing cleaning module of claim 1, wherein the controller is to control the vibrating mechanism to cause the platform to vibrate at a frequency ranging from 20 to 60 Hz.

3. The 3D printing cleaning module of claim 1, further comprising a tilting mechanism to cause the platform to tilt with respect to the horizontal plane and the controller to control the tilting mechanism to tilt upon completion of the cleaning operation.

4. The 3D printing cleaning module of claim 1, further comprising a drive mechanism to move the platform vertically and the controller is to control the drive mechanism to move the platform to a predetermined position so that the platform is directed to the extraction gate when the platform is in a tilted position.

5. The 3D printing cleaning module of claim 3, further comprising a sealing element between the platform and the housing that enables sealing regardless of the angle caused by the platform once tilted, wherein the angle is of the range of 0 to 15 degrees.

6. The 3D printing cleaning module of claim 3, wherein:
the tilting mechanism comprises:
a first drive mechanism attached to a first part of the platform, and
a second drive mechanism attached to a second part of the platform; and
the controller is to independently control the first and second drive mechanisms to tilt the platform.

7. The 3D printing cleaning module of claim 3, wherein:
the tilting mechanism comprises:
a first drive mechanism attached to a first part of the platform,
a second drive mechanism attached to a second part of the platform, and
a third drive mechanism attached to a third part of the platform;
wherein the first part, the second part, and the third part are spaced out defining a plane; and
wherein the controller is further to independently control the first, second and third drive mechanisms to tilt the platform.

8. The 3D printing cleaning module of claim 3, wherein the tilting mechanism is connectable to an external physical linkage actuatable to tilt the platform.

9. The 3D printing cleaning module of claim 1, wherein an outer part of the extraction gate is in such position that the 3D printed parts are to fall to a part conveying system.

10. The 3D printing cleaning module of claim 1, wherein ejection gate is controllable to:
open upwardly thereby enabling an external part collecting element to approach to the lateral wall of the housing; or
open downwardly thereby the ejection gate serving as an ejection ramp from the 3D cleaning module to an external part collecting element.

11. A method for cleaning and ejecting 3D printed parts from a 3D cleaning module, the method comprising:
supporting a build bed on a platform, the build bed including 3D printed parts and un-solidified build material, wherein the platform is tilted or tiltable with respect to a horizontal plane towards an extraction gate to enable 3D printed parts on the platform to be removable through the extraction gate;
executing a cleaning operation on the build bed comprising removing un-solidified build material of a build bed from the 3D cleaning module;
opening the ejection gate upon completion of the cleaning operation; and
extracting the 3D printed parts through the opened ejection gate.

12. The method of claim 11, further comprising tilting the platform through a tilting mechanism towards the extraction gate of the 3D cleaning module.

13. The method of claim 11, further comprising vibrating the platform by a vibrating mechanism when the part ejection gate is in the open position

14. A non-transitory machine-readable medium storing instructions executable by a processor, wherein a platform is to support a build bed including 3D printed parts and un-solidified build material, wherein the platform is tilted or tiltable with respect to a horizontal plane towards an extraction gate to enable 3D printed parts on the platform to be removable through the extraction gate, the non-transitory machine-readable medium comprising:
instructions to control a cleaning engine to execute a cleaning operation by removing un-solidified build material from the build bed;
instructions to open the ejection gate upon completion of the cleaning operation; and
instructions to cause a vibrating mechanism to vibrate the platform.

15. The non-transitory machine-readable medium of claim 14, further comprising instructions to cause a tilting mechanism to tilt the platform towards the part extraction gate.
